(19) United States
(12) Patent Application Publication
(10) Pub. No.: US 2015/0291140 A1
(43) Pub. Date: Oct. 15, 2015

(54) BRAKE DEVICE

(71) Applicant: ADVICS CO., LTD., Kariya-city, Aichi-pref (JP)

(72) Inventor: Satoshi Ishida, Chiryu-shi (JP)

(73) Assignee: ADVICS CO., LTD., Kariya-city, Aichi-pref. (JP)

(21) Appl. No.: 14/437,751

(22) PCT Filed: Oct. 23, 2013
(86) PCT No.: PCT/JP2013/078699

§ 371 Date: Apr. 22, 2015

(30) Foreign Application Priority Data
Oct. 23, 2012 (JP) 2012-234082

(51) Int. Cl. B60T 13/14

(52) U.S. Cl. CPC B60T 13/148; B60T 13/142

(57) ABSTRACT

A brake device sets a discharge amount of brake fluid by a pump as a target discharge amount that can generate, in cooperation with control of a reaction force hydraulic pressure increasing valve and a reaction force hydraulic pressure reducing valve, a target reaction force hydraulic pressure which is a target value of a reaction force hydraulic pressure in a reaction force chamber, and that can generate, in cooperation with control of a driving hydraulic pressure increasing valve and a driving hydraulic pressure reducing valve, a driving hydraulic pressure in a driving hydraulic pressure chamber. The brake device also controls the pump such that brake fluid of the target discharge amount is discharged by the pump and controls the valves such that the target reaction force hydraulic pressure is generated in the reaction force chamber and the target driving hydraulic pressure is generated in the driving hydraulic pressure chamber.

### TECHNICAL FIELD

The present invention relates to a vehicle brake device that can perform regenerative cooperative control, in which cooperation is performed between a service brake and a regenerative brake.

### BACKGROUND ART

In related art, regenerative cooperative control is performed in order to collect energy during braking as regenerative energy. In the regenerative cooperative control, when a brake pedal is depressed by a driver, a regenerative brake force is generated instead of a service brake force. When the regenerative cooperative control is performed, an input piston is moved by the depression of the brake pedal. At this time, if the input piston comes into contact with an output piston (an M/C piston that is provided in a master cylinder (hereinafter referred to as an M/C) and an M/C pressure is generated, the braking force by the service brake is generated and regenerative efficiency deteriorates.

In order to inhibit this, Patent Literature 1 proposes a vehicle braking device having a structure in which a gap is provided between the input piston and the output piston, taking account of a stroke amount that corresponds to a braking amount of the regenerative brake. Since the gap is provided between the input piston and the output piston in this manner, at the time of regenerative cooperation, it is possible to inhibit the input piston from coming into contact with the output piston until a maximum possible regenerative brake force is generated, and it is thus possible to achieve a maximum amount of regenerative efficiency.

In this vehicle braking device, a brake hydraulic pressure in an accumulator is held at a high pressure by pump drive, and the brake hydraulic pressure accumulated in the accumulator is used to apply the brake hydraulic pressure to each of pressure chambers. For example, by applying the brake hydraulic pressure to a reaction force chamber, a reaction force is applied to the brake pedal.

### CITATION LIST

### Patent Literature

[PTL 1]

Japanese Patent Application Publication No. JP-A-2007-55588

### SUMMARY OF INVENTION

### Technical Problem

However, with the structure in which the accumulator is used as in the vehicle braking device disclosed in Patent Literature 1, it is necessary to perform control such that the brake hydraulic pressure is accumulated at a very high pressure by the accumulator and is used by reducing it to a desired pressure. The pressure accumulated by the accumulator is approximately 16 Mpa, for example, and it is necessary to reduce the pressure to a low pressure, for example, approximately 1 Mpa. This type of control is performed by differential pressure control using a control valve. However, the pressure difference is large and therefore delicate control is required.

In light of the foregoing, it is an object of the present invention to provide a vehicle brake device that is capable of eliminating an accumulator while applying a reaction force to a brake operating member and generating an M/C pressure in a favorable manner.

### Solution to Problem

In order to achieve the above-described object, in an invention described in an first aspect, a brake device is provided that includes: a reaction force hydraulic pressure increasing valve that is provided in a reaction force fluid supply channel that leads brake fluid discharged from a pump to a reaction force chamber; a driving hydraulic pressure increasing valve that is provided in a driving fluid supply channel that leads the brake fluid discharged from the pump to a driving hydraulic pressure chamber; a reaction force hydraulic pressure reducing valve that is provided in a channel that connects, to an atmospheric pressure reservoir, a section of the reaction force fluid supply channel between the reaction force hydraulic pressure increasing valve and the reaction force chamber, or in a channel that connects the reaction force chamber and the atmospheric pressure reservoir and that is provided separately from the reaction force fluid supply channel; and a driving hydraulic pressure reducing valve that is provided in a channel that connects, to the atmospheric pressure reservoir, a section of the driving fluid supply channel between the driving hydraulic pressure increasing valve and the driving hydraulic pressure chamber, or in a channel that connects the driving hydraulic pressure chamber and the atmospheric pressure reservoir and that is provided separately from the driving fluid supply channel. The brake device is characterized in that control means controls the reaction force hydraulic pressure increasing valve, the reaction force hydraulic pressure reducing valve, the driving hydraulic pressure increasing valve and the driving hydraulic pressure reducing valve such that a target reaction force hydraulic pressure is generated in the reaction force chamber and a target driving hydraulic pressure is generated in the driving hydraulic pressure chamber.

In this manner, while the brake fluid is being discharged by the pump, the target reaction force hydraulic pressure is generated in the reaction force chamber by controlling the reaction force hydraulic pressure increasing valve and the reaction force hydraulic pressure reducing valve, and the target driving hydraulic pressure is generated in the driving hydraulic pressure chamber by controlling the driving hydraulic pressure increasing valve and the driving hydraulic pressure reducing valve. Thus, it is possible to eliminate an accumulator.

However, with the above-described structure, depending on a discharge amount of the brake fluid by the pump (hereinafter referred to as a pump discharge amount), a larger amount of the brake fluid than the brake fluid that can be discharged from the reaction force chamber to the atmospheric pressure reservoir via the reaction force hydraulic pressure reducing valve may flow into the reaction force chamber from the pump side via the reaction force hydraulic pressure increasing valve, or the brake fluid may flow out to the pump side from the driving hydraulic pressure chamber via the driving hydraulic pressure increasing valve. As a result, it is conceivable that situations may occur in which the target reaction force hydraulic pressure cannot be generated in the reaction force chamber or the driving hydraulic pressure cannot be generated in the driving hydraulic pressure chamber.

To address this, in an invention in a first aspect, the pump discharge amount that makes it possible to generate the target reaction force hydraulic pressure in the reaction force chamber and also makes it possible to generate the driving hydraulic pressure in the driving hydraulic pressure chamber is set as the target discharge amount, and the pump is controlled such that the brake fluid of the target discharge amount is discharged from the pump.

By doing this, it is possible to favorably apply a reaction force and generate an M/C pressure.

The above-described situations occur depending on relationships between the reaction force hydraulic pressure, the driving hydraulic pressure and the pump discharge amount.

To address this, in an invention in a second aspect, the target discharge amount is set based on a detection value of the reaction force hydraulic pressure and a detection value of the driving hydraulic pressure. In this manner, by setting an appropriate pump discharge amount with respect to the reaction force hydraulic pressure and the driving hydraulic pressure, it is possible to more favorably apply the reaction force and generate the M/C pressure.

According to knowledge of the inventors, a lower limit value of the pump discharge amount that makes it possible to generate the target reaction force hydraulic pressure in the reaction force chamber and also makes it possible to generate the target driving hydraulic pressure in the driving hydraulic pressure chamber can be derived by the reaction force hydraulic pressure and the driving hydraulic pressure.

Given this, in an invention in a third aspect, the above-described lower limit value is derived based on the detection value of the reaction force hydraulic pressure and the detection value of the driving hydraulic pressure, and the lower limit value is set as the target discharge amount. Thus, it is possible to favorably apply the reaction force and generate the M/C pressure, with a minimum pump discharge amount.

At the above-described lower limit value of the pump discharge amount, the reaction force hydraulic pressure matches a discharge hydraulic pressure that is a brake hydraulic pressure on the discharge side of the pump.

Given this, in an invention in a fourth aspect, the target discharge amount is set such that the reaction force hydraulic pressure matches the discharge hydraulic pressure. Therefore, if, instead of deriving the above-described lower limit value, the target discharge amount is set such that the reaction force hydraulic pressure matches the discharge hydraulic pressure, there is no need to provide driving hydraulic pressure detecting means in order to set the lower limit value, and it is possible to simplify the brake device. Further, if, as well as deriving the above-described lower limit value, the target discharge amount is set such that the reaction force hydraulic pressure matches the discharge pressure, it is possible to accurately set the target discharge amount.

Further, according to knowledge of the inventors, an upper limit of the pump discharge amount that makes it possible to generate the target reaction force hydraulic pressure in the reaction force chamber and also makes it possible to generate the driving hydraulic pressure in the driving hydraulic pressure chamber can be derived by the reaction force hydraulic pressure and the driving hydraulic pressure.

Given this, in an invention in a fifth aspect, the above-described lower limit value and the upper limit value are derived based on the detection value of the reaction force hydraulic pressure and the detection value of the driving hydraulic pressure, and a value that is between the lower limit value and the upper limit value is set as the target discharge amount. Thus, it is possible to reliably perform favorable reaction force application and favorable M/C pressure generation.

The discharge hydraulic pressure with respect to the pump discharge amount changes depending on a temperature of the brake fluid.

Given this, in an invention in a sixth aspect, the target discharge amount is set based on the temperature of the brake fluid. Thus, it is possible to favorably apply the reaction force and generate the M/C pressure, regardless of the temperature of the brake fluid.

### BRIEF DESCRIPTION OF DRAWINGS

FIG. 1 is a circuit schematic diagram showing an entire structure of a vehicle brake device 1 according to a first embodiment of the present invention.

FIG. 2 is a schematic diagram showing relationships between a flow rate and a flow passage area etc. of each of portions in a hydraulic pressure circuit provided in the brake device shown in FIG. 1.

FIG. 3 is a characteristic diagram showing relationships between a depression force F, a reaction force hydraulic pressure P1 and a driving hydraulic pressure P2.

FIG. 4 is a characteristic diagram showing relationships between the reaction force hydraulic pressure P1, the driving hydraulic pressure P2 and a motor rotation speed N (rpm).

FIG. 5 is a circuit schematic diagram showing an entire structure of the vehicle brake device 1 according to a second embodiment of the present invention.

FIG. 6 is a circuit schematic diagram showing an entire structure of the vehicle brake device 1 according to a third embodiment of the present invention.

### DESCRIPTION OF EMBODIMENTS

Hereinafter, embodiments of the present invention will be explained with reference to the drawings. Note that same reference numerals are assigned to parts that are the same as or equivalent to each other in each of the embodiments below.

### First Embodiment

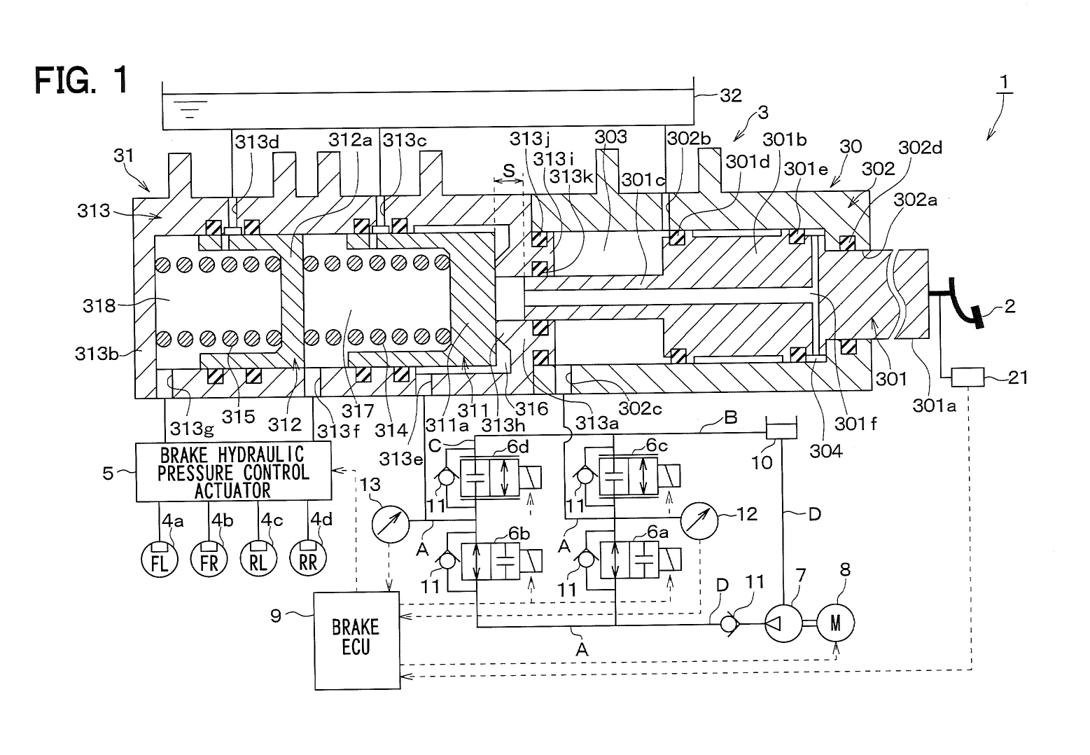

A first embodiment of the present invention will be explained. FIG. 1 is a diagram showing an entire structure of a vehicle brake device 1 to which the first embodiment of the present invention is applied. Hereinafter, the brake device 1 of the present embodiment will be explained with reference to FIG. 1.

As shown in FIG. 1, the brake device 1 is provided with a brake pedal 2, an M/C 3, W/Cs 4a to 4d, a brake hydraulic pressure control actuator 5, first to fourth control valves 6a to 6d, a pump 7, a motor 8, a brake ECU 9 and the like.

When the brake pedal 2 is depressed by a driver, it presses an input piston 301 that is provided inside the M/C 3. An operation amount of the brake pedal 2 is detected by an operation amount sensor 21. The operation amount sensor 21 is formed by, for example, a stroke sensor, a pedal force sensor or the like. When a detection signal of the operation amount sensor 21 is transmitted to the brake ECU 9, which is control means, the operation amount of the brake pedal 2 can be ascertained by the brake ECU 9. Note that, although here the brake pedal 2 is used as an example of a brake operating member, a brake lever or the like may be used.

The M/C 3 is formed by an input portion 30, an output portion 31 and a master reservoir 32. The input portion 30 is provided with the input piston 301 that is moved in response to the depression of the brake pedal 2. The output portion 31 is provided with M/C pistons 311 and 312 that correspond to output pistons that are moved when a service brake force is generated.

The input portion 30 is provided with the input piston 301 that is urged in response to the depression of the brake pedal 2, and a cylinder portion 302 that forms a space in which the input piston 301 is caused to slide and in which brake fluid is stored.

The input piston 301 is configured to have a pressure receiving portion 301a, a sliding portion 301b and a pressing portion 301c. The pressure receiving portion 301a is a portion to which the depression force of the brake pedal 2 is input, and is inserted into an opening portion 302a that is provided on one end of the cylinder portion 302. The diameter of the sliding portion 301b is larger than that of the pressure receiving portion 301a, and is the same size as or slightly smaller than the inner diameter of the cylinder portion 302. Sealing members 301d and 301e that are formed by O rings or the like are provided on an outer peripheral surface of the sliding portion 301b, and a seal is formed between the sliding portion 301b and the cylinder portion 302. The pressing portion 301c is smaller than the sliding portion 301b in diameter, and is configured to protrude in an axial direction from the sliding portion 301b toward the output portion 31. The leading end of the pressing portion 301c is arranged to be separated from the M/C piston 311 by a gap S.

Further, a communicating passage 301f is provided inside the pressing portion 301c and the sliding portion 301b. The communicating passage 301f extends from the leading end of the pressing portion 301c and is connected further to the brake pedal 2 side than a sealing member 301e on the outer peripheral surface of the sliding portion 301b. The communicating passage 301f allows flow of the brake fluid in a space that is formed by the gap S between the leading end of the pressing portion 301c and the M/C piston 311.

The cylinder portion 302 causes the input piston 301 to slide in the axial direction while securing the seal between the outer peripheral surface of the sliding portion 301b and an inner wall surface of the cylinder portion 302 using the sealing members 301d and 301e. Formed in the cylinder portion 302 are the opening portion 302a into which the pressure receiving portion 301a is inserted, a communicating passage 302b to communicatively connect with the master reservoir 32 that is maintained at an atmospheric pressure, and a communicating passage 302c to communicatively connect with a hydraulic pressure circuit that is formed by the control valves 6a to 6d and the pump 7 etc. The sealing member 302d is provided on an inner wall surface of the opening portion 302a, and a seal is formed between the opening portion 302a of the cylinder portion 302 and an outer peripheral surface of the pressure receiving portion 301a.

The input portion 30 is formed by the structure described above. In the input portion 30 formed in this manner, the input piston 301 is arranged inside the cylinder portion 302, and thus a reaction force chamber 303 is formed further to the output portion 31 side than the sliding portion 301b inside the cylinder portion 302. The reaction force chamber 303 is connected via the communicating passage 302c to the hydraulic pressure circuit that is formed by the control valves 6a to 6d and the pump 7 etc.

Further, a back chamber 304 is formed further to the brake pedal 2 side than the sealing member 301e inside the cylinder portion 302. The back chamber 304 is formed by the outer periphery of the sliding portion 301b and by portions located further to the brake pedal 2 side than the sliding portion 301b. The back chamber 304 is communicatively connected to the space that is formed by the gap S between the leading end of the pressing portion 301c and the M/C piston 311, through the communicating passage 301f formed inside the pressing portion 301c and the sliding portion 301b. Then, based on the movement of the input piston 301, the volume of the back chamber 304 and the volume of the space that is formed by the gap S between the leading end of the pressing portion 301c and the M/C piston 311 change. However, the area of the difference between the inner diameter of the cylinder portion 302 and the outer diameter of the pressure receiving portion 301a is matched with the area of the leading end of the pressing portion 301c so that change amounts of the volumes are the same. Therefore, even when the input piston 301 is moved to one of the sides in the axial direction inside the cylinder portion 302, it is possible to inhibit a reaction force due to the movement from being generated.

Note that, before the brake pedal 2 is depressed, the communicating passage 302b is arranged on the side that is further separated from the brake pedal 2 than the sealing member 301d. However, when the input piston 301 is moved by the depression of the brake pedal 2, the communicating passage 302b is arranged such that it is immediately positioned closer to the brake pedal 2 than the sealing member 301d. Therefore, when the brake pedal 2 is depressed, the inside of the reaction force chamber 303 and the master reservoir 32 are immediately blocked, and it is possible to increase the brake hydraulic pressure in the reaction force chamber 303.

The output portion 31 is configured to have the M/C pistons 311 and 312, a cylinder portion 313 and return springs 314 and 315.

The M/C piston 311 is a primary piston and the M/C piston 312 is a secondary piston, and the M/C pistons 311 and 312 are coaxially arranged inside the cylinder portion 313 such that the M/C piston 311 is closer to the input piston 301 than the M/C piston 312. The M/C pistons 311 and 312 have a bottomed cylindrical shape and are arranged inside the cylinder portion 313 such that bottom portions 311a and 312a are directed to the input piston 301 side. Thus, a driving hydraulic pressure chamber 316 is formed between the bottom portion of the M/C piston 311 and one end surface 313a of the cylinder portion 313, and at the same time, a primary chamber 317 between the M/C piston 311 and the M/C piston 312 and a secondary chamber 318 between the M/C piston 312 and the other end of the cylinder portion 313 are formed.

The cylinder portion 313 has a hollow cylindrical shape that has the two end surfaces 313a and 313b, and houses the M/C pistons 311 and 312 inside the hollow portion.

Communicating passages 313c to 313g are formed on an outer peripheral wall of the cylinder portion 313. When the M/C pistons 311 and 312 are located in initial positions when the service brake force is not generated, the communicating passages 313c and 313d communicatively connect the master reservoir 32 maintained at the atmospheric pressure with the primary chamber 317 and the secondary chamber 318, respectively. When the M/C pistons 311 and 312 are moved from the initial positions, the communicating passages 313c and 313d are blocked by outer peripheral surfaces of the M/C pistons 311 and 312. The communicating passage 313e communicatively connects the driving hydraulic pressure chamber 316 with the hydraulic pressure circuit that is formed by the control valves 6a to 6d and the pump 7 etc. The communicating passages 313f and 313g communicatively connect the primary chamber 317 and the secondary chamber 318 with a first piping system and a second piping system in a brake hydraulic pressure circuit, respectively.

Further, the inner diameter of the cylinder portion 313 is larger on the bottom portion side of the M/C piston 311. Further, a protruding portion 313h that protrudes from the one end surface 313a of the cylinder portion 313 toward the M/C piston 311 side is provided, and thus a gap is provided between the one end surface 313a of the cylinder portion 313 and the bottom portion of the M/C piston 311. The driving hydraulic pressure chamber 316 is formed by the section of the cylinder portion 313 whose inner diameter is larger and the gap between the one end surface 313a of the cylinder portion 313 and the bottom portion of the M/C piston 311.

Note that, in the drawings, although the cylinder portion 313 is depicted as a single member, it is formed by combining and integrating a plurality of members.

The return springs 314 and 315 are respectively arranged between the M/C piston 311 and the M/C piston 312 and between the M/C piston 312 and the other end surface 313b of the cylinder portion 313. The return springs 314 and 315 generate a reaction force when the M/C piston 312 is urged to the left side of the drawing, and act to return the M/C pistons 311 and 312 to the input piston 301 side when the service brake force is not generated.

The output portion 31 is formed by the structure described above. Then, the input portion 30 and the output portion 31 are integrated by the leading end portions of the two cylinder portions 302 and 313 being connected, specifically, by an insertion portion 313i on the opposite side to the protruding portion 313h of the one end surface 313a of the cylinder portion 313 being fitted into the cylinder portion 302, and thus the M/C 3 is formed. Note that a sealing member 313j that is formed by an O ring or the like is provided on the outer peripheral side of the insertion portion 313i, and sealing performance with the cylinder portion 302 is secured. Further, a sealing member 313k that is formed by an O ring or the like is provided on the inner peripheral side of the insertion portion 313i, and sealing performance is secured between the reaction force chamber 303 and the bottom portion side of the M/C piston 311.

The W/Cs 4a to 4d are each communicatively connected to the primary chamber 317 or the secondary chamber 318 via the brake hydraulic pressure control actuator 5. For example, in the case of front-rear piping, the W/Cs 4a and 4b of left and right front wheels FL and FR are connected to the primary chamber 317 via the first piping system, and the W/Cs 4c and 4d of left and right rear wheels RL and RR are connected to the secondary chamber 318 via the second piping system. When the same brake hydraulic pressure (M/C pressure) is generated for the primary chamber 317 and the secondary chamber 318 of the M/C 3, the generated brake hydraulic pressure is transmitted to each of the W/Cs 4a to 4d via the brake hydraulic pressure control actuator 5. Thus, the W/C pressure is generated and the braking force is generated for each of the wheels FL to RR.

The brake hydraulic pressure control actuator 5 is an actuator that forms a brake hydraulic pressure circuit for adjusting the W/C pressure. Specifically, the brake hydraulic pressure control actuator 5 forms a plurality of pieces of piping to perform control of the brake hydraulic pressure for a metal housing, and various electromagnetic valves and a pump are connected to the piping formed in the housing. At the same time, a pump driving motor is fixed to the housing, thus forming a brake hydraulic pressure circuit between the M/C 3 and the W/Cs 4a to 4d. Then, by the brake ECU 9 driving the various electromagnetic valves or driving the motor to actuate the pump, the brake hydraulic pressure in the brake hydraulic pressure circuit is controlled and the W/C pressure is adjusted. Note that the structure of the brake hydraulic pressure control actuator 5 is known and a detailed explanation thereof is thus omitted here.

The first to fourth control valves 6a to 6d correspond to a reaction force hydraulic pressure increasing valve, a driving hydraulic pressure increasing valve, a reaction force hydraulic pressure reducing valve and a driving hydraulic pressure reducing valve, in that order, and are formed by two-position solenoid valves that can be switched between a communicatively connected state and a blocked state. The first and second control valves 6a and 6b are of a constantly open type and the third and fourth control valves 6c and 6d are of a constantly closed type. The pump 7 performs suction and discharge operations of the brake fluid based on the drive of the motor 8.

Specifically, the first to fourth control valves 6a to 6d and the pump 7 form the hydraulic pressure circuit that is provided between the reaction force chamber 303 of the input portion 30 and the driving hydraulic pressure chamber 316 of the output portion 31. A pipe line A connects between the reaction force chamber 303 and the driving hydraulic pressure chamber 316, and the constantly open type first and second control valves 6a and 6b are provided in the pipe line A. Further, a pipe line B connects between the atmospheric pressure reservoir 10 and the reaction force chamber 303 and the first control valve 6a in the pipe line A, and the constantly closed type third control valve 6c is provided in the pipe line B. Further, a pipe line C connects between the driving hydraulic pressure chamber 316 and the second control valve 6b in the pipe line A, and the constantly closed type fourth control valve 6d is provided in the pipe line C. Further, a pipe line D connects between the atmospheric pressure reservoir 10 and the first control valve 6a and the second control valve 6b in the pipe line A, and the pump 7 is provided in the pipe line D. Note that check valves 11 are provided in parallel with the respective control valves 6a to 6d, and the check valve 11 is provided on a discharge port side of the pump 7 in order to inhibit the brake fluid from flowing from the driving hydraulic pressure chamber 316 side to the reaction force chamber 303 or the atmospheric pressure reservoir 10 at the time of valve closure, and to inhibit a high pressure from being applied to the discharge port of the pump 7.

Further, a first pressure sensor 12 is provided on a section of the pipe line A that is closer to the reaction force chamber 303 than the first control valve 6a, and a second pressure sensor 13 is provided on a section of the pipe line A that is closer to the driving hydraulic pressure chamber 316 than the second control valve 6b. The reaction force hydraulic pressure in the reaction force chamber 303 and the driving hydraulic pressure in the driving hydraulic pressure chamber 316 are monitored by the first and second pressure sensors 12 and 13, and detection signals of the first and second pressure sensors 12 and 13 are input to the brake ECU 9. Then, based on the reaction force hydraulic pressure in the reaction force chamber 303 and the driving hydraulic pressure in the driving hydraulic pressure chamber 316, the brake ECU 9 controls the first to fourth control valves 6a to 6d and drives the motor 8 to actuate the pump 7. Thus, the brake ECU 9 performs operations, such as generating a reaction force in response to the depression of the brake pedal 2 during regenerative braking, adjusting the M/C pressure, and the like.

The brake device 1 according to the present embodiment is structured in the manner described above. Next, operations of the brake device 1 that is structured in this manner will be explained, respectively, in case of normal operation and in case of abnormal operation (power supply failure).

(1) Operations During Normal Operation

During normal operation, more specifically, when the brake ECU 9 and the like are not broken down and the control valves 6a to 6d, the motor 8 and the like can be driven normally, the operation amount of the brake pedal 2 is monitored based on detection signals of the operation amount sensor 21 and the first and second pressure sensors 12 and 13, and at the same time, brake pressures in the reaction force chamber 303 and the driving hydraulic pressure chamber 316 are monitored.

Further, the second control valve 6b is switched to the blocked state and the motor 8 is driven to actuate the pump 7. Therefore, until the leading end of the pressing portion 301c of the input piston 301 comes into contact with the M/C piston 311 in accordance with the depression of the brake pedal 2, the second control valve 6b is caused to be in the blocked state and the M/C pressure is not generated. In other words, in regenerative cooperative control, it is possible to inhibit the input piston 301 from coming into contact with the M/C piston 311, which is the output piston, until a maximum possible regenerative brake force is generated, and it is possible to achieve a maximum amount of regenerative efficiency.

Since the first control valve 6a is in a communicatively connected state, the brake fluid is introduced into the reaction force chamber 303 by the suction and discharge operations of the pump 7. Thus, the reaction force hydraulic pressure in the reaction force chamber 303 is increased, and a pedal reaction force is applied to the brake pedal 2 via the input piston 301. At this time, based on results of monitoring by the operation amount sensor 21 and the first pressure sensor 12, the brake hydraulic pressure in the reaction force chamber 303 is adjusted by the third control valve 6c so that the pedal reaction force can be generated in accordance with the operation amount of the brake pedal 2. More specifically, by adjusting the amount of power distribution to the solenoid of the third control valve 6c, a differential pressure between the upstream and downstream sides of the third control valve 6c is linearly controlled. It is thus possible to apply a pedal reaction force to the brake pedal 2 in accordance with the operation amount.

After that, when the operation amount of the brake pedal 2 is increased and the maximum amount that can be generated as the regenerative brake force is reached, the second control valve 6b is brought into a communicatively connected state. Thus, the brake fluid is also introduced into the driving hydraulic pressure chamber 316, and the brake hydraulic pressure in the driving hydraulic pressure chamber 316 increases. As a result, the M/C pistons 311 and 312 are pressed to the left side of the drawing and the M/C pressure is generated. Further, at the same time, the fourth control valve 6d is actuated and the brake hydraulic pressure in the driving hydraulic pressure chamber 316 is adjusted based on results of monitoring by the operation sensor 21 and the second pressure sensor 13. It is thus possible to generate a braking force obtained by subtracting the regenerative brake force from the braking force that is generated in accordance with the operation amount of the brake pedal 2.

When the M/C pressure is generated in this manner, the generated M/C pressure is transmitted to each of the W/Cs 4a to 4d via the brake hydraulic pressure control actuator 5. It is thus possible to generate a desired braking force.

In this manner, even when the accumulator is eliminated from the hydraulic pressure circuit that has the first to fourth control valves 6a to 6d, the pump 7, the motor 8 and the reservoir 10, it is possible to apply a reaction force to the brake pedal 2 and to generate the M/C pressure in a favorable manner.

Note that, in the structure of the present embodiment, the hydraulic pressure circuit is connected to the two systems of the pressure chamber 303 and the driving hydraulic pressure chamber 316. Although depending on settings of a pressure receiving system, such as a piston area, generally, the brake hydraulic pressures of the two systems need not necessarily be the same and are different pressures. When it is attempted to maintain the pressures of the two systems at different pressures, they can only be controlled to certain pressures due to the flow passage diameter of the first to fourth control valves 6a to 6d that are in separate systems and the discharge amount of the pump 7. Further, in the above-described structure, depending on relationships between the reaction force hydraulic pressure, the driving hydraulic pressure and the pump discharge amount, a larger amount of the brake fluid than the brake fluid that can be discharged from the reaction force chamber 303 to the atmospheric pressure reservoir 10 via the control valve 6c may flow into the reaction force chamber 303 from the pump 7 side via the first control valve 6a, or the brake fluid may flow out to the pump 7 side from the driving hydraulic pressure chamber 316 via the second control valve 6b. As a result, situations that may occur are conceivable in which a target reaction force hydraulic pressure cannot be generated in the reaction force chamber 303 or the driving hydraulic pressure cannot be generated in the driving hydraulic pressure chamber 316.

Accordingly, if the motor 8 is formed, for example, by a constant rotation motor that can be driven only at a certain rotation speed, it is not possible to control the discharge amount of the pump 7 to a desired value, and the reaction force hydraulic pressure in the pressure chamber 303 and the driving hydraulic pressure in the driving hydraulic pressure chamber 316 cannot be controlled to target control pressures (a target reaction force hydraulic pressure and a target driving hydraulic pressure). Therefore, in the present embodiment, a motor for which rotation speed control is possible, such as a brushless motor, for example, is used as the motor 8 and the rotation speed control is performed based on a rotation detection function that is provided in the motor 8. Hereinafter, a specific concept of the rotation speed control for the motor 8 will be explained.

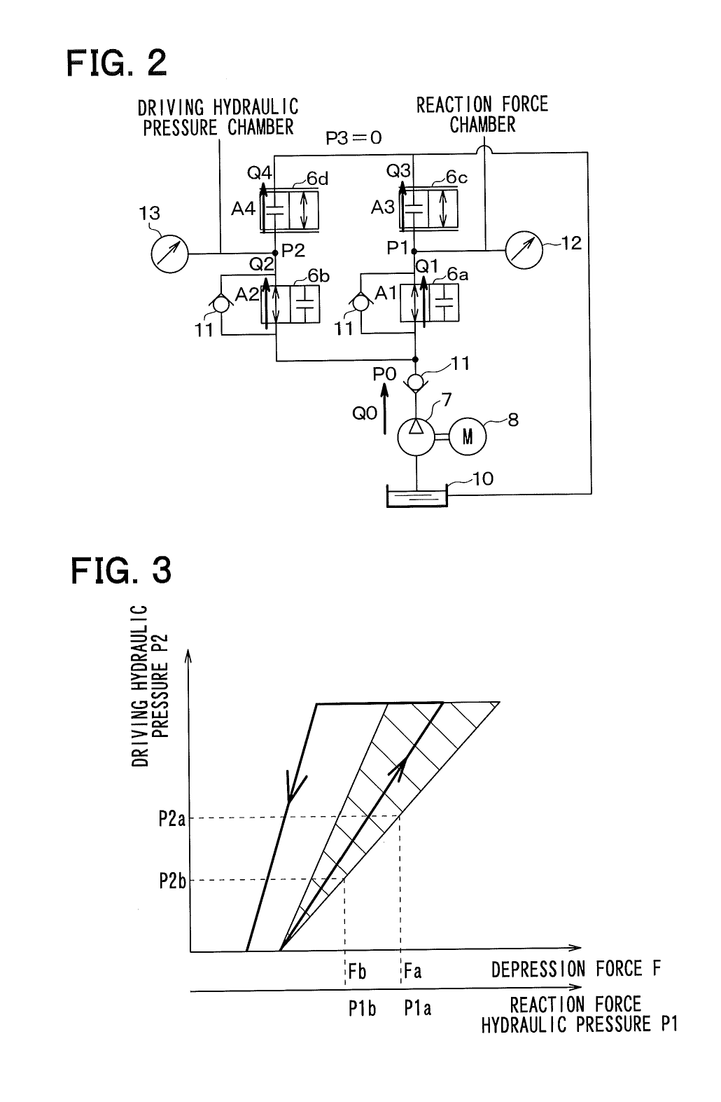

FIG. 2 is a schematic diagram showing relationships between a flow rate and a flow passage area etc. of each of portions in the hydraulic pressure circuit provided in the brake device shown in FIG. 1.

As shown in FIG. 2, a pump discharge pressure (a discharge hydraulic pressure that is the brake hydraulic pressure on the discharge side of the pump 7) is denoted by P0, a pressure between the first control valve 6a and the third control valve 6c, namely, a reaction force hydraulic pressure, is denoted by P1, a pressure between the second control valve 6b and the fourth control valve 6f, namely, a driving hydraulic pressure, is denoted by P2, and a pressure of the reservoir 10 is denoted by P3 (=0). Further, flow passage areas of the first to fourth control valves 6a to 6d are respectively denoted by A1 to A4, a discharge amount of the brake fluid from the pump 7 is denoted by Q0, and flow rates of the brake fluid flowing through the first to fourth control valves 6a to 6d are denoted by Q1 to Q4, respectively.

When the reaction force hydraulic pressure P1 and the driving hydraulic pressure P2 are controlled to given pressures, it is necessary to satisfy the condition that the pump discharge pressure P0 be equal to or larger than P1 and equal to or larger than P2. In other words, it is necessary for the pump 7 to be constantly maintained in a discharge state.

If P1≦P2 is established in the relationship between the pressure hydraulic pressure P1 and the driving hydraulic pressure P2, since P0≧P1 and P0≧P2 is established as described above, the minimum value of the pump discharge pressure P0 is equal to P2, and unless the pump discharge pressure P0 becomes equal to or more than P2, the brake fluid flows from the driving hydraulic pressure P2 side to the reaction force hydraulic pressure P1 side due to a pressure difference. Therefore, it is necessary to secure a predetermined discharge amount for the pump 7. Further, if equations of the flow rates flowing through the respective control valves 6a to 6d are written, relationships of the following Equations 2 to 5 are obtained. Here, C is a flow coefficient and ρ is a fluid density (brake fluid density). Note that, although C changes depending on the temperature etc. of the brake fluid, here, it is assumed to be a constant value. Further, A1 to A4 are constant values.

Q1=C·A1·(2(P0−P1)/ρ)½ (Equation 1)

Q2=C·A2·(2(P0−P2)/ρ)½ (Equation 2)

Q3=C·A3·(2(P1−P3)/ρ)½ (Equation 3)

Q4=C·A4·(2(P2−P3)/ρ)½ (Equation 4)

Note that, since the pressure P3 of the reservoir 10 is equal to 0, Equations 3 and 4 can be simplified and expressed by Equations 5 and 6.

Q3=C·A3·(2P1/ρ)½ (Equation 5)

Q4=C·A4·(2P2/ρ)½ (Equation 6)

Here, based on each of the above equations, a lower limit value of the discharge amount of the pump 7 (hereinafter referred to as a lower limit pump discharge amount Qmin) and an upper limit value (hereinafter referred to as an upper limit pump discharge amount Qmax) can be defined in the following manner.

(i) Lower Limit Pump Discharge Amount Qmin (Where it is Assumed that P1≦P2)

When it is assumed that P1≦P2, the lower limit pump discharge amount Qmin is a required minimum discharge amount of the pump 7 in order to inhibit the brake fluid from flowing from the driving hydraulic pressure P2 side to the reaction force hydraulic pressure P1 side due to a pressure difference.

As described above, when P0=P2, the pump discharge amount becomes minimum. Thus, the brake fluid does not flow to the driving hydraulic pressure chamber 316 side, and all the brake fluid flows to the reaction force chamber 303 side. More specifically, the discharge amount Q0 of the pump 7 becomes equal to the flow rate Q1 of the brake fluid of the first control valve 6a, and Q0=Q1 is established. Given this, when P0=P2 is substituted into Equations 1 and 2, Equations 7 and 8 are derived.

Q1=C·A1·(2(P2−P1)/ρ)½ (Equation 7)

Q2=0 (Equation 8)

Accordingly, the flow rate Q1 of the brake fluid of the first control valve 6a that is shown by Equation 7 becomes equal to the lower limit pump discharge amount Qmin. Since the reaction force hydraulic pressure P1 and the driving hydraulic pressure P2 are target pressures of the reaction force chamber 303 and the driving hydraulic pressure chamber 316, the lower limit pump discharge amount Qmin becomes a function of the pressures P1 and P2 of the respective chambers 303 and 316.

The lower limit pump discharge amount Qmin can be set in this manner. The actual flow rate Q0 discharged by the pump 7 can be controlled by the rotation speed of the motor 8. More specifically, if the discharge amount of the pump 7 per one rotation is denoted by V (cc/rev) and the motor rotation speed is denoted by N (rpm), the discharge amount Q0 (cc/sec) of the pump 7 is Q0=V·N/60. Therefore, by controlling the motor rotation speed N (rpm), it is possible to control the discharge amount Q0 of the pump 7. Note that the motor rotation speed N when the discharge amount Q0 of the pump 7 becomes equal to the lower limit pump discharge amount Qmin is referred to as a motor lower limit rotation speed Nmin.

(ii) Upper Limit Pump Discharge Amount Qmax (Where it is Assumed that P1≦P2)

The upper limit pump discharge amount Qmax is an upper limit value of the discharge amount Q0 of the pump 7 that is necessary to hold the same pressures as the reaction force hydraulic pressure P1 and the driving hydraulic pressure P2 set at (i).

When the rotation speed of the motor 8 is increased from the above-described state of P1=P2, the pump discharge pressure P0 becomes larger than the driving hydraulic pressure chamber P2 (P0>P2), and the brake fluid discharged from the pump 7 flows out to the two systems of the driving hydraulic pressure chamber 316 and the reaction force chamber 303.

At this time, in order to hold the reaction force hydraulic pressure P1 and the driving hydraulic pressure P2 set at (i), the brake fluid that excessively flows in has to be discharged from the third and fourth control valves 6c and 6d to the reservoir 10 side. However, the flow rates of the brake fluid that can be caused to flow through the third and fourth control valves 6c and 6d are determined by Equations 3 and 4. Therefore, if the brake fluid of a flow rate larger than that flows in, it is not possible to hold the reaction force hydraulic pressure P1 and the driving hydraulic pressure P2 set at (i). Therefore, the discharge amount of the pump 7 also reaches a limit (an upper limit).

Further, in a state in which the discharge amount of the pump 7 reaches the upper limit, the flow rates Q1 and Q3 of the brake fluid of the first control valve 6a and the third control valve 6c satisfy Q1=Q3, or the flow rates Q2 and Q4 of the brake fluid of the second control valve 6b and the fourth control valve 6d satisfy Q2=Q4. Therefore, Equations 9 and 11 can be derived from Equations 1 and 5, and the pump discharge pressure P0 can be expressed by Equations 10 and 12 based on Equations 9 and 11.

C·A1·(2(P0−P1)/ρ)½=C·A3·(2P1/ρ)½ (Equation 9)

P0=(A3/A1)2·P1+P1 (Equation 10)

C·A2·(2(P0−P2)/ρ)½=C·A4·(2P2/ρ)½ (Equation 11)

P0=(A4/A2)2·P2+P2 (Equation 12)

Then, a smaller one of the values of the pump discharge pressure P0 expressed by Equations 10 and 12 is the upper limit pump discharge amount Qmax. The smaller one of the values of the pump discharge pressure P0 expressed by Equations 10 and 12 is determined by the flow passage areas A1 to A4 of the first to fourth control valves 6a to 6d, the reaction force hydraulic pressure P1 and the driving hydraulic pressure P2.

The upper limit pump discharge amount Qmax can be set in this manner. Then, one of the values of the pump discharge pressure P0 expressed by Equations 10 and 12 that is set to a smaller value is substituted into Equations 1 and 2, and thus the flow rates Q1 and Q2 of the brake fluid of the first and second control valves 6a and 6b are obtained. By adding the obtained flow rates Q1 and Q2, Qmax can be calculated (Qmax=Q1+Q2). The motor rotation speed at this time can also be defined in a similar manner to the case of the lower limit pump discharge amount Qmin. Since Qmax=V·N/60, by controlling the motor rotation speed N (rpm), it is possible to control the discharge amount Q0 of the pump 7. Note that the motor rotation speed N when the discharge amount Q0 of the pump 7 becomes equal to the upper limit pump discharge amount Qmax is referred to as a motor upper limit rotation speed Nmax.

In the manner described above, the lower limit pump discharge amount Qmin and the upper limit pump discharge amount Qmax are obtained, and the motor lower limit rotation speed Nmin and the motor upper limit rotation speed Nmax that correspond to them can be calculated. Therefore, when the reaction force hydraulic pressure P1 in the reaction force chamber 303 and the driving hydraulic pressure P2 in the driving hydraulic pressure chamber 316 are to be controlled to given target control values (the target reaction force hydraulic pressure and the target driving hydraulic pressure), the discharge amount of the pump 7 that is set as a target (a target discharge amount) may be controlled within the range of Qmin≦Q0≦Qmax. In other words, the motor rotation speed N may be controlled within the range of Nmin≦N≦Nmax. Therefore, if the motor 8 is formed by a motor for which the rotation speed control is possible, such as a brushless motor, and the motor rotation speed N is controlled, it is possible to favorably control the reaction force hydraulic pressure P1 and the driving hydraulic pressure P2 to given target control pressures. Thus, while applying a reaction force to the brake pedal 2 and generating the M/C pressure in a favorable manner, it is possible to eliminate the accumulator in which the brake fluid has to be accumulated at a high pressure.

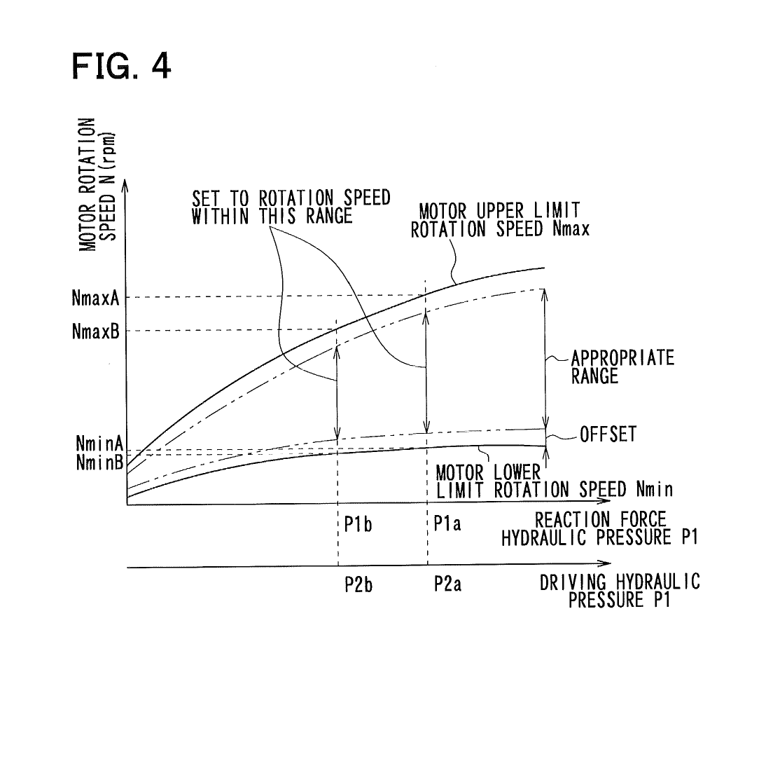

For example, as shown in FIG. 3, the reaction force hydraulic pressure P1 is set to a value corresponding to a depression force F that is applied to the brake pedal 2, and the relationship of the driving hydraulic pressure P2 with respect to the reaction force hydraulic pressure P1 is set to a desired relationship. A desired increase gradient and decrease gradient of the driving hydraulic pressure P2 have a relationship of hysteresis with respect to an increase and decrease in the reaction force hydraulic pressure P1. For example, as shown by a hatched area in the drawing, a certain tolerance range is set for the increase gradient etc. Further, relationships between the reaction force hydraulic pressure P1 and the driving hydraulic pressure P2 to be generated, and the motor rotation speed N (rpm) are shown in FIG. 4.

As shown in FIG. 3, when the reaction force hydraulic pressure P1 that corresponds to a depression force Fa is P1a and the driving hydraulic pressure P2 that corresponds to P1a is P2a, the motor lower limit rotation speed Nmin and the motor upper limit rotation speed Nmax to generate the pressures P1a and P2a are NminA and NmaxA, as shown in FIG. 4. Further, as shown in FIG. 3, when the reaction force hydraulic pressure P1 that corresponds to a depression force Fb is P1b and the driving hydraulic pressure P2 that corresponds to P1b is P2b, the motor lower limit rotation speed Nmin and the motor upper limit rotation speed Nmax to generate the pressures P1b and P2b are NminB and NmaxB, respectively, as shown in FIG. 4. In this manner, the motor lower limit rotation speed Nmin and the motor upper limit rotation speed Nmax are determined based on the reaction force hydraulic pressure P1 and the driving hydraulic pressure P2 to be generated. Therefore, the motor rotation speed N is controlled to become a rotation speed within a range between Nmin and Nmax. For example, as the reaction force hydraulic pressure P1 and the driving hydraulic pressure P2 to be generated become larger, the motor lower limit rotation speed Nmin and the motor upper limit rotation speed Nmax become larger. Therefore, the motor rotation speed N is also controlled such that it becomes larger as the reaction force hydraulic pressure P1 and the driving hydraulic pressure P2 become larger. By doing this, it is possible to favorably control the reaction force hydraulic pressure P1 and the driving hydraulic pressure P2 to given target control pressures.

At this time, basically, the motor rotation speed N may be set to a rotation speed within the range between the motor lower limit rotation speed Nmin and the motor upper limit rotation speed Nmax. However, due to manufacturing variations of the first control valves 6a to 6d, the pump 7 and the motor 8 etc., there is a possibility of variations in the motor lower limit rotation speed Nmin and the motor upper limit rotation speed Nmax. Therefore, within the range between the motor lower limit rotation speed Nmin and the motor upper limit rotation speed Nmax, it is preferable to set, as an appropriate range, a range excluding a range assumed to be variation, namely to set a range excluding a range from the motor lower limit rotation speed Nmin to a rotation speed that is higher than Nmin by a predetermined rotation speed and excluding a range from the motor upper limit rotation speed Nmax to a rotation speed that is lower than Nmax by the predetermined rotation speed, and it is preferable to set the motor rotation speed N within the appropriate range. In this case, the discharge amount of the pump 7 when the motor 8 is rotated at a rotation speed obtained by adding the predetermined rotation speed to the motor lower limit rotation speed Nmin corresponds to a “lower limit value” in the scope of the claims, and the discharge amount of the pump 7 when the motor 8 is rotated at a rotation speed obtained by adding the predetermined rotation speed to the motor upper limit rotation speed Nmax corresponds to an “upper limit value” in the scope of the claims.

Thus, the motor rotation speed N can be set taking manufacturing variations into consideration, and it is possible to more favorably control the reaction force hydraulic pressure P1 and the driving hydraulic pressure P2 to given target control pressures. For example, it is possible to set, as the appropriate range, a range obtained by excluding the upper quarter range and the lower quarter range from the range between the motor lower limit rotation speed Nmin and the motor upper limit rotation speed Nmax.

Further, as the motor rotation speed N increases, motor operation sound increases. Therefore, taking quietness into consideration, it is preferable to reduce the motor rotation speed N as much as possible. Therefore, if the lower limit value within the above-described appropriate range is set, the motor operation sound can be reduced while taking variations into consideration, and it is possible to improve quietness. Note that, here, the appropriate range is set taking variations into consideration and the lower limit of the appropriate range is set as the motor rotation speed N. However, the range obtained by taking variations into consideration is, to some extent, already determined. Therefore, even when the rotation speed obtained by adding the predetermined rotation speed to the motor lower limit rotation speed Nmin is set as the motor rotation speed N, it is possible to reduce the motor operation sound while taking variations into consideration, and it is possible to improve quietness. In this case, the discharge amount of the pump 7 when the motor 8 is rotated at the rotation speed obtained by adding the predetermined rotation speed to the motor lower limit rotation speed Nmin corresponds to the “lower limit value” in the scope of the claims.

(2) Operations During Abnormality

During abnormality, namely, when the brake ECU 9 or the like fails and it is not possible to normally drive the control valves 6a to 6d and the motor 8 etc., the first to fourth control valves 6a to 6d and the motor 8 cannot be actuated. Therefore, the first to fourth control valves 6a to 6d remain in the positions shown in the drawing.

If the brake pedal 2 is depressed in this state, the input piston 301 is moved to the left side of the drawing and the brake fluid in the reaction force chamber 303 is moved through the pipe line A into the driving hydraulic pressure chamber 316. More specifically, since both the first and second control valves 6a and 6b are in the communicatively connected state and both the third and fourth control valves 6c and 6d are in the blocked state, the brake fluid corresponding to the amount of the brake fluid pushed out from the reaction force chamber 303 is introduced into the driving hydraulic pressure chamber 316.

Thus, the M/C pistons 311 and 312 are pressed to the left side of the drawing by the brake hydraulic pressure in the driving hydraulic pressure chamber 316, and the M/C pressure is generated. When the M/C pressure is generated in this manner, the generated M/C pressure is transmitted to each of the W/Cs 4a to 4d via the brake hydraulic pressure control actuator 5. This makes it possible to generate a desired braking force. Therefore, even during abnormality, it is possible to generate a braking force before the input piston 301 comes into contact with the M/C piston 311 that is the output piston, and even when the gap S is provided between the input piston 301 and the M/C piston 311, it is possible to eliminate an invalid stroke.

As explained above, according to the brake device 1 of the present embodiment, the reaction force chamber 303 that changes the reaction force hydraulic pressure in accordance with the movement of the input piston 301 and the driving hydraulic pressure chamber 316 that is connected to the reaction force chamber 303 via the hydraulic pressure circuit are provided inside the M/C 3, and the first to fourth control valves 6a to 6d and the pump 7 are provided in the hydraulic pressure circuit. Thus, the reaction force hydraulic pressure is generated in the reaction force chamber 303 and the driving hydraulic pressure in the driving hydraulic pressure chamber 316 is adjusted. More specifically, the brake ECU 9 controls the first to fourth control valves 6a to 6d and sets the discharge amount of the brake fluid by the pump 7 as the target discharge amount that makes it possible to generate the target control pressures (the target reaction force hydraulic pressure and the target driving hydraulic pressure) as the reaction force hydraulic pressure and the driving hydraulic pressure. Then, the pump 7 is controlled so that the brake fluid of the target discharge amount is discharged from the pump 7, and the first to fourth control valves 6a to 6d are controlled so that the reaction force hydraulic pressure and the driving hydraulic pressure become equal to the target control pressures (the target reaction force hydraulic pressure and the target driving hydraulic pressure).

In this manner, while applying a reaction force to the brake pedal 2 and generating the M/C pressure in a favorable manner, it is possible to eliminate the accumulator in which the brake fluid has to be accumulated at a high pressure. Further, it is possible to eliminate control of delicate control valves. In addition, since the accumulator can be eliminated, it is possible to downsize the brake device and consequently, it is possible to achieve a reduction in manufacturing costs of the brake device.

### Second Embodiment

A second embodiment of the present invention will be explained. As explained in the above-described first embodiment, the reaction force hydraulic pressure P1 matches the pump discharge pressure P0 at the lower limit value of the target discharge amount of the pump 7. For that reason, it is also possible to set the target discharge amount such that the reaction force hydraulic pressure P1 matches the pump discharge pressure P0, instead of deriving the lower limit value as described above.

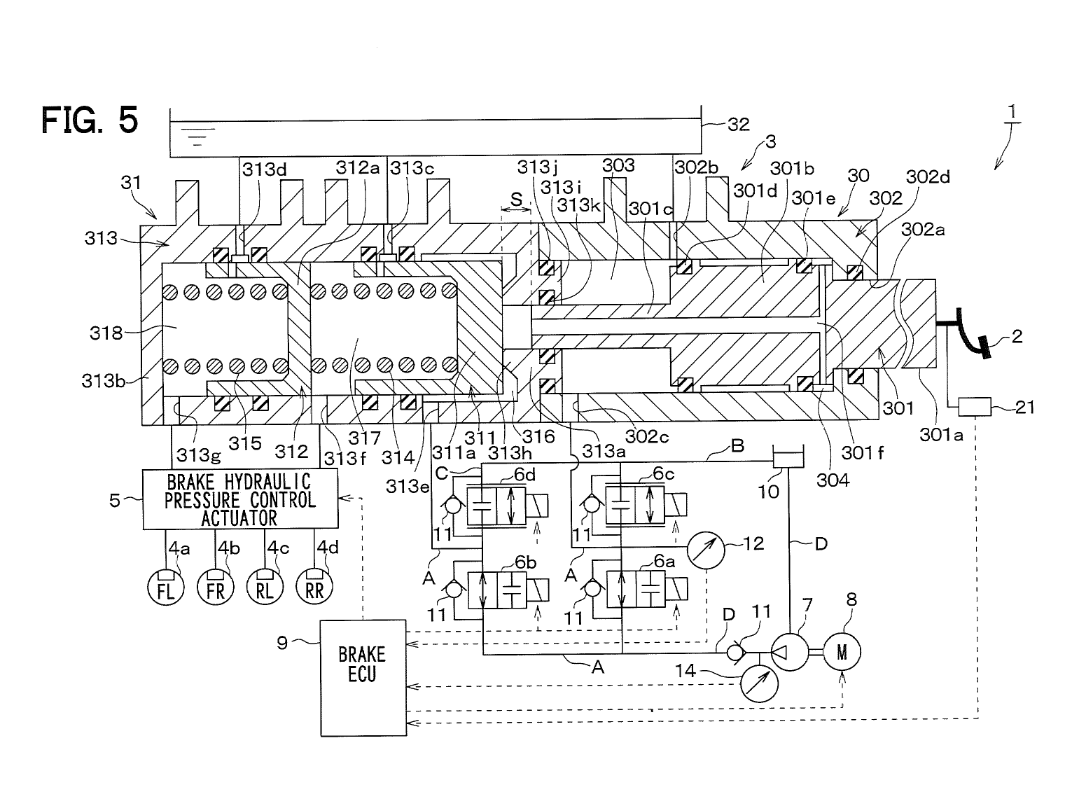

FIG. 5 is a circuit schematic diagram showing an entire structure of the vehicle brake device 1 according to the present embodiment. As shown in this drawing, a third pressure sensor 14 is provided as discharge pressure detecting means on the discharge side of the pump 7. The target discharge amount is set such that the pump discharge pressure P0 detected by the third pressure sensor 14 matches the reaction force hydraulic pressure P1 detected by the first pressure sensor 12.

If this is done, it is not necessary to provide the second pressure sensor 13, which corresponds to driving hydraulic pressure detecting means for detecting the driving hydraulic pressure P3, in order to set the lower limit value, as in the first embodiment, and it is possible to simplify the brake device. If, as well as deriving the above-described lower limit value, the target discharge amount is set such that the reaction force hydraulic pressure P1 matches the pump discharge pressure P0, it is also possible to accurately set the target discharge amount.

### Third Embodiment

A third embodiment of the present invention will be explained. In the above-described first embodiment, changes in temperature of the brake fluid are not taken into consideration. However, in the present embodiment, the target discharge amount of the pump 7 is set while taking into consideration changes in temperature of the brake fluid.

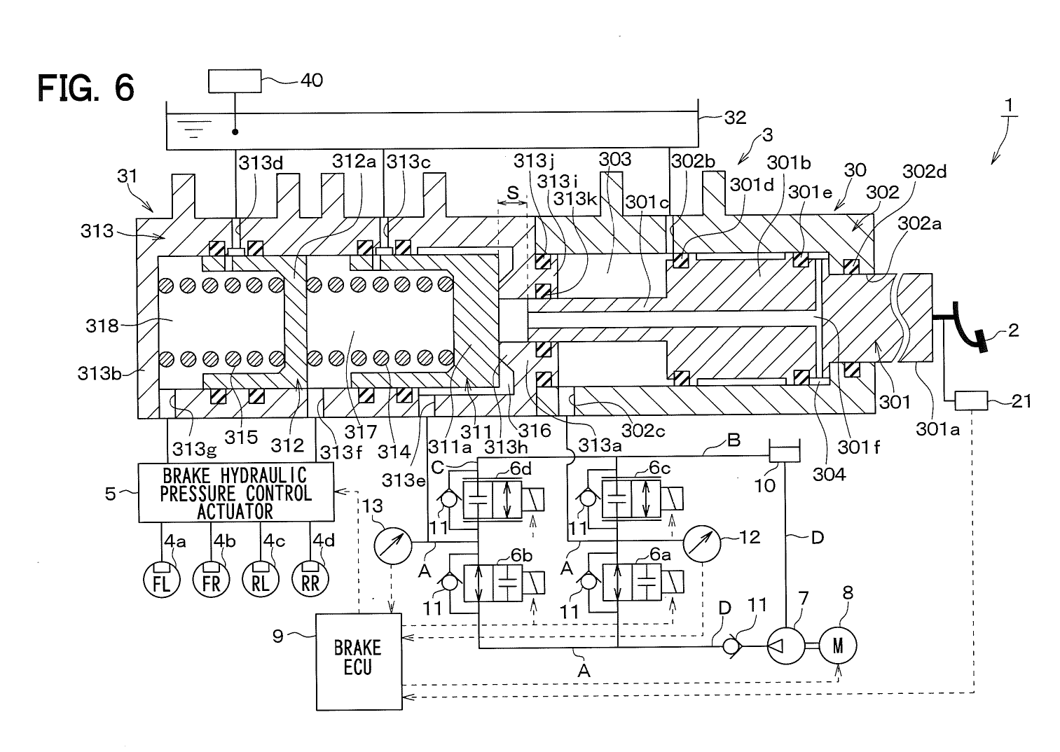

FIG. 6 is a circuit schematic diagram showing an entire structure of the vehicle brake device 1 according to the present embodiment. As shown in this drawing, in contrast to the first embodiment, a temperature sensor 40 that corresponds to temperature detecting means is provided so that the temperature of the brake fluid can be detected in the master reservoir 32, for example. The temperature of the brake fluid indicated by a detection signal of the temperature sensor 40 is input to the brake ECU 9, and the brake ECU 9 sets the target discharge amount of the pump 7 based on the temperature of the brake fluid. Specifically, when the temperature of the brake fluid changes, the viscosity of the brake fluid changes, and consequently, the back pressure of the pump 7 changes. As a result, the discharge pressure with respect to the discharge amount of the pump 7 changes.

Based on this, by setting the discharge amount of the pump 7 based on the temperature of the brake fluid, it is possible to apply a reaction force and generate the M/C pressure in a favorable manner, regardless of the temperature of the brake fluid.

### Other Embodiments

The present invention is not limited to the above-described embodiments and can be changed as appropriate within the scope described in the claims.

For example, in the above-described embodiments, the case is explained in which the atmospheric pressure reservoir 10 that stores the brake fluid that is maintained at the atmospheric pressure is provided separately from the master reservoir 32. However, it is also possible to use the master reservoir 32 as the atmospheric pressure reservoir 10.

Further, in the above-described embodiments, the pressure sensors 12 and 13 are provided as reaction force hydraulic pressure detecting means for detecting the reaction force hydraulic pressure and the driving hydraulic pressure detecting means for detecting the driving hydraulic pressure. However, the reaction force hydraulic pressure and the driving hydraulic pressure can also be estimated from an amount of current supplied to the solenoids for driving the third and fourth control valves 6c and 6d. However, in comparison to the case in which the pressure sensors 12 and 13 are used for detection, there are large variations in the reaction force hydraulic pressure and the driving hydraulic pressure that are estimated from the amount of current supplied to the solenoids. Therefore, when the pressure sensors 12 and 13 are used, the reaction force hydraulic pressure and the driving hydraulic pressure can be detected more accurately.

Further, in the above-described embodiments, the target discharge amount of the pump 7 is set based on a detection value of the reaction force hydraulic pressure that is detected by the reaction force hydraulic pressure detecting means and a detection value of the driving hydraulic pressure that is detected by the driving hydraulic pressure detecting means. Specifically, the lower limit value of the target discharge amount of the pump 7 that makes it possible to generate the target control pressures (the target reaction force hydraulic pressure and the target driving hydraulic pressure) is derived based on the reaction force hydraulic pressure and the driving hydraulic pressure that are detected, and the target discharge amount is set to the derived lower limit value. Alternatively, the lower limit value and the upper limit value of the target discharge amount are derived and a value between them is set as the target discharge amount. This type of setting of the target discharge amount may be performed without providing the reaction force hydraulic pressure detecting means and the driving hydraulic pressure detecting means. In other words, the target discharge amount that corresponds to the target reaction force hydraulic pressure and the target driving hydraulic pressure may be set in a feed-forward manner.

In the above-described embodiments, the motor lower limit rotation speed Nmin and the motor upper limit rotation speed Nmax are calculated based on the reaction force hydraulic pressure P1 and the driving hydraulic pressure P2, and the motor rotation speed N is set based on the motor lower limit rotation speed Nmin and the motor upper limit rotation speed Nmax.

However, a map that indicates relationships between the motor rotation speed N and the reaction force hydraulic pressure P1 and the driving hydraulic pressure P2 may be stored in a memory, and the motor rotation speed N that corresponds to the reaction force hydraulic pressure P1 and the driving hydraulic pressure P2 may be acquired. Further, a map that indicates relationships between the motor lower limit rotation speed Nmin and the reaction force hydraulic pressure P1 and the driving hydraulic pressure P2 may be stored in a memory, and the motor lower limit rotation speed Nmin that corresponds to the reaction force hydraulic pressure P1 and the driving hydraulic pressure P2 may be acquired. Further, a map that indicates relationships between the motor upper limit rotation speed Nmax and the reaction force hydraulic pressure P1 and the driving hydraulic pressure P2 may be stored in a memory, and the motor upper limit rotation speed Nmax that corresponds to the reaction force hydraulic pressure P1 and the driving hydraulic pressure P2 may be acquired.

In the above-described embodiments, the structure is explained in which the channel that discharges, to the atmospheric pressure reservoir 10, the brake fluid that is closer to the reaction force chamber 303 than the first control valve 6a, which is the reaction force hydraulic pressure increasing valve, is partially common to the channel that leads the brake fluid discharged from the pump 7 to the reaction force chamber 303. However, it may be provided separately from the channel that leads the brake fluid discharged from the pump 7 to the reaction force chamber 303. Then, the third control valve 6c, which is the reaction force hydraulic pressure reducing valve, may be provided in this channel.

Further, the structure is explained in which the channel that discharges, to the atmospheric pressure reservoir 10, the brake fluid that is closer to the driving hydraulic pressure chamber 316 than the second control valve 6b, which is the driving hydraulic pressure increasing valve, is partially common to the channel that leads the brake fluid discharged from the pump 7 to the driving hydraulic pressure chamber 316. However, it may be provided separately from the channel that leads the brake fluid discharged from the pump 7 to the driving hydraulic pressure chamber 316. Then, the fourth control valve 6d, which is the driving hydraulic pressure reducing valve, may be provided in this channel.

Note that, in each of the above-described embodiments, various types of channels of the present invention are formed by the pipe lines A to D that are provided in the hydraulic pressure circuit. For example, the channel that leads the brake fluid discharged from the pump 7 to the reaction force chamber 303 corresponds to a reaction force fluid supply channel, and the channel that leads the brake fluid discharged from the pump 7 to the driving hydraulic pressure chamber 316 corresponds to a driving fluid supply channel.

Further, in each of the above-described embodiments, a portion that includes the M/C pistons 311 and 312 and the M/C 3 that separates the driving hydraulic pressure chamber 316 from the reaction force chamber 303, together with the M/C pistons 311 and 312, corresponds to a hydraulic pressure generating device.

### REFERENCE SIGNS LIST

1 . . . Brake device
2 . . . Brake pedal
3 . . . M/C
4a to 4d . . . W/C
5 . . . Brake hydraulic pressure control actuator
6a to 6d . . . First to fourth control valves
7 . . . Pump
8 . . . Motor
10 . . . Atmospheric pressure reservoir
12, 13 . . . Pressure sensor
21 . . . Operation amount sensor
30 . . . Input portion
31 . . . Output portion
301 . . . Input piston
302 . . . Cylinder portion
303 . . . Reaction force chamber
304 . . . Back chamber
311, 312 . . . M/C piston
313 . . . Cylinder portion
316 . . . Driving hydraulic pressure chamber
317 . . . Primary chamber
318 . . . Secondary chamber
A to D . . . Pipe line

1. A brake device that comprises:
a hydraulic pressure generating device that includes a master cylinder piston and a master cylinder that separates, together with the master cylinder piston, a driving hydraulic pressure chamber from a reaction force chamber, wherein a driving hydraulic pressure that becomes a driving force to drive the master cylinder piston is generated in the hydraulic pressure chamber, and a reaction force hydraulic pressure that is a reaction force against an operation force applied to a brake operating member is generated in the reaction force chamber;
a pump that discharges brake fluid;
an atmospheric pressure reservoir that stores the brake fluid that is maintained at an atmospheric pressure;
a reaction force hydraulic pressure increasing valve that is provided in a reaction force fluid supply channel that leads the brake fluid discharged from the pump to the reaction force chamber;
a driving hydraulic pressure increasing valve that is provided in a driving fluid supply channel that leads the brake fluid discharged from the pump to the driving hydraulic pressure chamber;
a reaction force hydraulic pressure reducing valve that is provided in a channel that connects a section of the reaction force fluid supply channel between the reaction force hydraulic pressure increasing valve and the reaction force chamber to the atmospheric pressure reservoir, or in a channel that connects the reaction force chamber and the atmospheric pressure reservoir and that is provided separately from the reaction force fluid supply channel; and
a driving hydraulic pressure reducing valve that is provided in a channel that connects a section of the driving fluid supply channel between the driving hydraulic pressure increasing valve and the driving hydraulic pressure chamber to the atmospheric pressure reservoir, or in a channel that connects the driving hydraulic pressure chamber and the atmospheric pressure reservoir and that is provided separately from the driving fluid supply channel;
the brake device further comprising:
pump discharge amount setting means for setting a discharge amount of the brake fluid by the pump as a target discharge amount that makes it possible to generate, in cooperation with control of the reaction force hydraulic pressure increasing valve and the reaction force hydraulic pressure reducing valve, a target reaction force hydraulic pressure which is a target value of the reaction force hydraulic pressure in the reaction force chamber, and that also makes it possible to generate, in cooperation with control of the driving hydraulic pressure increasing valve and the driving hydraulic pressure reducing valve, the driving hydraulic pressure in the driving hydraulic pressure chamber;
pump control means for controlling the pump such that the brake fluid of the target discharge amount set by the pump discharge amount setting means is discharged by the pump; and
control means for controlling the reaction force hydraulic pressure increasing valve, the reaction force hydraulic pressure reducing valve, the driving hydraulic pressure increasing valve and the driving hydraulic pressure reducing valve such that the target reaction force hydraulic pressure is generated in the reaction force chamber and the target driving hydraulic pressure is generated in the driving hydraulic pressure chamber.

2. The brake device according to claim 1, further comprising:
reaction force hydraulic pressure detecting means for detecting the reaction force hydraulic pressure; and
driving hydraulic pressure detecting means for detecting the driving hydraulic pressure;
wherein
the pump discharge amount setting means sets the target discharge amount based on a detection value of the reaction force hydraulic pressure detected by the reaction force hydraulic pressure detecting means and on a detection value of the driving hydraulic pressure detected by the driving hydraulic pressure detecting means.

3. The brake device according to claim 2, wherein the pump discharge amount setting means derives a lower limit value of the pump's discharge amount that makes it possible to generate the target reaction force hydraulic pressure in the reaction force chamber and also makes it possible to generate the target driving hydraulic pressure in the driving hydraulic pressure chamber, based on the reaction force hydraulic pressure detected by the reaction force hydraulic pressure detecting means and the driving hydraulic pressure detected by the driving hydraulic pressure detecting means, and sets the lower limit value as the target discharge amount.

4. The brake device according to claim 2, further comprising:
discharge pressure detecting means for detecting a discharge hydraulic pressure, which is a hydraulic pressure of the brake fluid on a discharge side of the pump;
wherein
the pump discharge amount setting means sets the target discharge amount such that the reaction force hydraulic pressure detected by the reaction force hydraulic pressure detecting means matches the discharge hydraulic pressure detected by the discharge pressure detecting means.

5. The brake device according to claim 2, wherein the pump discharge amount setting means derives a lower limit value and an upper limit value of the pump's discharge amount that makes it possible to generate the target reaction force hydraulic pressure in the reaction force chamber and also makes it possible to generate the target driving hydraulic pressure in the driving hydraulic pressure chamber, based on the reaction force hydraulic pressure detected by the reaction force hydraulic pressure detecting means and the driving hydraulic pressure detected by the driving hydraulic pressure detecting means, and sets a value that is between the lower limit value and the upper limit value as the target discharge amount.

6. The brake device according to claim 1, further comprising:
temperature detecting means for detecting a temperature of the brake fluid;
wherein
the pump discharge amount setting means sets the target discharge amount based on the temperature of the brake fluid detected by the temperature detecting means.
